(19) United States
(12) Patent Application Publication
(10) Pub. No.: US 2026/0098468 A1
(43) Pub. Date: Apr. 9, 2026

(54) SYSTEM AND METHOD OF QUANTIFYING CARBON DIOXIDE STORAGE

(71) Applicant: RESMAN AS, Ranheim (NO)

(72) Inventors: Gunnar HVIDING, Ranheim (NO); Øyvind DUGSTAD, Ranheim (NO); Edmund LEUNG, Ranheim (NO)

(21) Appl. No.: 19/114,128

(22) PCT Filed: Sep. 22, 2023
(86) PCT No.: PCT/EP2023/076310

§ 371 Date: Mar. 21, 2025

(30) Foreign Application Priority Data
Sep. 23, 2022 (GB) GB2213941.4

(51) Int. Cl. E21B 47/11; E21B 41/00; F17D 5/02; G01M 3/20; G01N 31/22

(52) U.S. Cl. CPC E21B 47/11; E21B 41/0064; F17D 5/02; G01M 3/20; G01N 31/223

(57) ABSTRACT

The invention provides a system and method of estimating the amount of carbon dioxide stored in a storage formation. The method comprises associating at least one carbon dioxide source with at least one tracer and injecting the carbon dioxide from the at least one carbon dioxide source into the storage formation. The method comprises collecting samples from one or more sampling location and measuring the concentration of the tracer in the at least one sample. The method comprises inferring from the presence or absence of the tracer in the sample the amount of injected carbon dioxide remaining in the storage formation.

The present invention relates to the storage of carbon dioxide, in particular to the storage of carbon dioxide in underground formations. Aspects of the invention relate to a system and method of quantifying an amount of stored carbon dioxide in a formation. The invention has particular, although not exclusive, application to carbon quota and carbon credit systems.

### BACKGROUND TO THE INVENTION

Carbon Capture Utilisation and Storage (CCUS) is the process of capturing carbon dioxide (CO₂) from industrial processes, or directly from the atmosphere, so that it can be stored deep underground in subsurface formations. Captured CO₂ is injected into subsurface formations such as oil and gas reservoirs, coal seams or salt dome reservoirs to store it permanently.

Increasing awareness of global warming and new climate goals to tackle climate change and its impacts are delivering unprecedented momentum for capturing and removing carbon to reduce carbon emissions.

Carbon quota and carbon credit systems are components of national and international attempts to mitigate future global warming. Carbon quotas are based on cumulative global CO₂ emissions. The global carbon quota are in turn divided in regional and national limits which can legally be emitted.

Industries and other emitters will increasingly be subject to the quota system, where CO₂ emission limits for a particular activity are set by a centralized authority. The quota limit may be constant or reduced over time, thus incentivising the emitter to adopt new technology or improve processes to reduce emissions. The quotas may apply to a group of emitters (for example all companies producing oil and gas in a certain jurisdiction). If one emitter is able to reduce its emissions below its assigned quota, the emitter can sell any unused quota to another emitter, thus the unused quota becomes a tradable financial instrument.

The credit system is a voluntary CO₂ reduction scheme. The credit system applies to emitters who are not regulated by the quota system. The credit system is thus a private initiative and the participants can be corporations, organisations or even private individuals.

Carbon credits arise from capturing CO₂ from a point source or direct air capture. The captured CO₂ is injected and stored into a safe underground storage. When this process is completed, a carbon credit may be claimed for each ton of CO₂ stored. The carbon credits may be sold to an emitter, so that the emitter can ‘offset’ its emission using the acquired credits.

Permanently storing injected carbon dioxide is essential to mitigate undermining the value of the carbon quota and carbon credit systems.

### SUMMARY OF THE INVENTION

There is a need to mitigate carbon credits being issued for non-permanently stored carbon dioxide. There is also a need to understand the impact of leaking carbon dioxide to emission quotas.

There is generally a need for a system and method of quantifying carbon dioxide storage which addresses one or more of the problems associated with Carbon Capture Utilisation and Storage, including improved understanding, transparency and verification of CO₂ storage used in the carbon quota and/or carbon credit systems.

It is amongst the aims and objects of the invention to provide a system and method of quantifying carbon dioxide storage which obviates or mitigates one or more drawbacks or disadvantages of the prior art carbon dioxide storage systems.

It is an object of an aspect of the present invention to provide a system and method of quantifying carbon dioxide storage to reliably trace stored injected carbon dioxide for carbon credit systems and/or carbon quota system.

It is another object of an aspect of the present invention to reliably determine whether produced carbon dioxide was previously injected into the reservoir by a source which was counted towards the source's carbon credits and/or carbon quota.

Further aims and objects of the invention will become apparent from reading the following description.

According to a first aspect of the invention, there is provided a method of estimating an amount of injected carbon dioxide stored in a storage formation;
the method comprising;
associating carbon dioxide from at least one carbon dioxide source with at least one tracer;
injecting the carbon dioxide from the at least one carbon dioxide source into the storage formation;
taking at least one sample from one or more sampling location;
measuring the concentration of the tracer in the at least one sample;
inferring from the presence or absence of the at least one tracer in the sample a leak of the injected carbon dioxide from the at least one carbon dioxide source from the storage formation.

The method may comprise establishing a carbon credit value based on the amount of carbon dioxide remaining in the storage formation. The method may comprise establishing a carbon credit value based on the amount of carbon dioxide released from the storage formation. The method may comprise establishing a carbon quota offset value based on the amount of carbon dioxide remaining in the storage formation. The method May comprise establishing a carbon quota offset value based on the amount of carbon dioxide released from the storage formation.

By associating carbon dioxide with at least one tracer it is meant labelling, tagging, mixing, infusing, co-injecting, tracing and/or characterising a component of carbon dioxide using at least one tracer. The at least one tracer may be added to the carbon dioxide and migrate, be carried by, or travel with the carbon dioxide. The least one tracer may be bonded or non-bonded to the carbon dioxide. The least one tracer may be a characteristic or chemical signature of the carbon dioxide or a component of the carbon dioxide. By taking at least one sample it is meant collecting least one sample. The collected samples may be further analysis onsite or offsite. The at least one sample may be taken by real time measurement. The at least one sample may be gas and/or liquid samples. The method may comprise collecting samples from one or more sampling locations. The method may comprise collecting samples at known sampling times.

The at least one tracer may be an artificial tracer or a natural tracer. The at least one tracer may be distinctive for each carbon dioxide source. The at least one tracer may be selected from the group comprising chemical, fluorescent, phosphorescent, DNA, isotope, isotope signature. stable isotope, radioactive isotope, of elements constituting a part of a tracer molecule. The at least one tracer may comprise stable or radioactive isotopes of elements constituting a part of a tracer molecule. The tracer may be carbon dioxide containing a naturally occurring isotope of a component of carbon dioxide.

The method may comprise quantifying the amount of injected carbon dioxide remaining in the storage formation. The method may comprise quantifying the amount of injected carbon dioxide permanently stored in the storage formation. The method may comprise quantifying the amount of injected carbon dioxide remaining in the storage formation based on the measured tracer concentration. The method may comprise quantifying the amount of carbon dioxide leaking from the storage formation based on the measured tracer concentration. The method may comprise identifying at least one naturally occurring tag in the carbon dioxide. The at least one naturally occurring tag may be an isotope or an isotope ratio. The method may comprise detecting and/or quantifying the amount of carbon isotope in the at least one sample. The at least one tracer may be an isotope signature of carbon dioxide from the injected carbon dioxide source. The method may comprise detecting and/or quantifying the amount of isotope signature in the at least one sample. The method may comprise quantifying the amount of carbon dioxide remaining in the storage formation based on measuring the amount of two or more tracers in the at least one sample wherein one of the two or more tracers is the isotope signature. The method may comprise injecting a known amount of carbon dioxide and/or tracer from the at least one carbon dioxide source into the storage formation. The method may comprise injecting the carbon dioxide by continuous injection or by pulse injection. The rate of injection May be measured volumetrically and/or by mass flow rate with a flow measurement device. The injected CO₂ may be measured on a regular basis to determine flow rate. The method May comprise taking at least one sample from the storage formation before the injection of carbon dioxide to create a baseline measurement. The method may comprise measuring the concentration of the at least one tracer and/or the at least one naturally occurring tag in the at least one sample. The one or more samples may be taken at known sampling times. Sampling may occur downhole and/or at surface. The one or more sampling locations may surround, partially surround, be in proximity and/or be connected to the storage formation. The one or more sampling locations may be a well, production well and/or observation well. The one or more sampling locations may be a downhole or at surface of a well, production well and/or observation well. The one or more sampling locations may be a section of seabed or land surface. The collected samples may be analysed for of the presence of the at least one tracers. The samples collected may be analysed for direct tracer concentrations. The samples collected may be analysed for isotope ratios.

The method may comprise assessing CO₂ volumes produced back and the CO₂ volumes stored in the reservoir based on the detection of the tracer, the concentration of tracer in the samples, concentration of tracer in the samples as a function of time, the detection of isotope, the quantification of isotope, sampling time and/or transport time. The method may comprise quantification of CO₂ volumes based on tracer dilution, arrival time measurements, residence time, swept volume, 3D (4D) seismic data, geometric data, well logging tools, gravimetry and/or production data. The method may comprise quantification of tracer concentrations down to parts per trillion level. The method may comprise measuring at least one naturally occurring isotope by gas proportional counting, liquid scintillation counting, and/or mass spectrometry.

The method may comprise quantifying the amount of injected carbon dioxide remaining in the storage formation based on the measured concentration of the at least one tracer in the collected samples. The method may comprise analysing the concentration the at least one tracer in the samples as a function of time to estimate the amount of injected carbon dioxide stored in the underground storage formation. The method may comprise quantifying the amount of carbon dioxide remaining in the storage formation based on the arrival time of the at least one tracer in the collected samples. The method may comprise quantifying or characterising a carbon dioxide plume or migration path based on the arrival time of the at least one tracer in the collected samples. The method may comprise calculating a residence time distribution of the at least one tracer in the underground storage formation and/or a swept volume of the at least one tracer in the underground storage formation.

The method may comprise creating a model of the storage formation. The method may comprise creating a model to determine upper and lower carbon dioxide levels in the underground storage formation. The model may simulate characteristics of the reservoir and/or pathways of injected carbon dioxide. The model may comprise parameters selected from the group comprising seismic data, geological data, reservoir geometry, core data, log data, reservoir and/or pathways of injected carbon dioxide, modelled migration pathways, rock mechanics, temperature, pressure, gravity, density, viscosity; reservoir permeability, reservoir heterogeneities, solubility, fluid chemistry; porosity, fluid saturation, modelled tracer and carbon dioxide injection including tracer and carbon dioxide amounts, volumes and injection rates, injection locations, leakage locations, arrival time, residence time distribution, physical behaviour of CO₂ and/or chemical behaviour of CO. The method may comprise updating the model based upon measured and/or calculated data. The method may comprise history matching. The method may comprise comparing historical parameter measurements to calculated data. The method may comprise adjusting one or more parameter measurements of the model until a reasonable match is achieved between the measured and calculated data. The model may simulate characteristics of the reservoir and/or pathways of injected carbon dioxide and at least one tracer. The method may comprise comparing modelled tracer sample data to measured tracer sample data.

The storage formation may be an underground storage formation. The storage formation may be a reservoir, a subsurface reservoir, an oil and/or gas reservoir, a saline formation, an abandoned coal seam, an organic-rich shale and/or a basalt formation. The method may comprise identifying the source of a leak of carbon dioxide stored in a storage formation based on the characteristics of the at least one tracer in the at least one sample.

According to a second aspect of the invention, there is provided a method of estimating the amount of carbon dioxide stored in a storage formation;
the method comprising:
associating a first carbon dioxide source with at least a first tracer;
associating a second carbon dioxide source with at least a second tracer;
injecting a known amount of carbon dioxide from the first and/or second carbon dioxide sources into the storage formation;
taking at least one sample from one or more sampling location;
measuring the concentration of the first and/or second tracers in the at least one sample;
inferring from the presence or absence of the first and/or second tracer in the sample whether injected carbon dioxide from the first and/or second carbon dioxide sources is leaking from the storage formation.

The method may comprise inferring from the presence of the first and/or second tracers the amount of injected carbon dioxide from the first and second first and second carbon dioxide sources remaining in the storage formation.

The method may comprise quantifying the amount of injected carbon dioxide from each source remains in the storage formation. The method may comprise quantifying the amount of injected carbon dioxide remaining from each source in the storage formation based on the measured concentration of the first and/or second tracers. The method May comprise quantifying the amount of carbon dioxide leaking from the storage formation based on the measured concentration of the first and/or second tracers. The method May comprise identifying at least one naturally occurring tag in the carbon dioxide. The at least one naturally occurring tag may be an isotope. The method may comprise detecting and/or quantifying the quantity of carbon isotope in the at least one sample. The first and/or second carbon dioxide source may be carbon dioxide captured from an oil and gas process. The method may comprise collecting samples from one or more sampling locations. The method may comprise collecting samples at known sampling times. The method may comprise collecting a plurality of samples.

Embodiments of the second aspect of the invention may include one or more features of the first aspect of the invention or its embodiments, or vice versa.

According to a third aspect of the invention, there is provided a method for estimating an amount of injected carbon dioxide stored in a storage formation wherein the storage formation comprising carbon dioxide injected from at least one carbon dioxide source;
wherein injected carbon dioxide from each carbon dioxide source is associated with at least one tracer;
the method comprising:
taking at least one sample from one or more sampling location;
measuring the concentration of the tracer in the at least one sample;
inferring from the presence or absence of the at least one tracer in the sample a leak of the injected carbon dioxide from the at least one carbon dioxide source from the storage formation.

The method may comprise estimating the amount of injected carbon dioxide from the at least one carbon dioxide source stored in the underground storage formation. The method may comprise collecting samples from one or more sampling locations. The method May comprise collecting samples at known sampling times. The method may comprise collecting a plurality of samples.

Embodiments of the third aspect of the invention may include one or more features of the first or second aspects of the invention or its embodiments, or vice versa.

According to a fourth aspect of the invention, there is provided a method of characterising and/or identifying the source of a leak of carbon dioxide stored in a storage formation;
the method comprising:
providing a plurality of carbon dioxide sources;
associating each carbon dioxide source with at a distinctive tracer specific for each carbon dioxide source;
injecting a known amount of carbon dioxide from at least one of the carbon dioxide sources into the storage formation;
taking at least one sample from one or more sampling location;
measuring the concentration of tracer in the at least one sample;
inferring from the presence or absence of at least one tracer in the sample the carbon dioxide injection source of the carbon dioxide leaking from the storage formation.

The method may comprise injecting a known amount of carbon dioxide from two or more carbon dioxide sources into the storage formation. The method may comprise measuring the concentration one or more tracers in the at least one sample. The method May comprise inferring from the presence of one or more tracer in the sample the amount of injected carbon dioxide from the two or carbon dioxide sources remaining in the storage formation. The method may comprise quantifying the amount of injected carbon dioxide from each carbon dioxide source remaining in the storage formation. The method May comprise quantifying the amount of injected carbon dioxide from each carbon dioxide source leaking from the storage formation. The method may comprise characterising and/or identifying the source of a leak of carbon dioxide stored in a storage formation based on the characteristics of the at least one tracer and/or an isotope signature of carbon dioxide in the collected samples. The method may comprise collecting samples from one or more sampling locations. The method may comprise collecting samples at known sampling times. The method may comprise collecting a plurality of samples.

Embodiments of the fourth aspect of the invention may include one or more features of the first to third aspects of the invention or their embodiments, or vice versa.

According to a fifth aspect of the invention, there is provided a method for detecting a leak from a carbon dioxide storage formation wherein the storage formation comprises carbon dioxide from at least one carbon dioxide source;
wherein carbon dioxide from at least one carbon dioxide source is associated with at least one tracer;
the method comprising;
taking at least one sample from one or more sampling location;
measuring the concentration of the tracer in the at least one sample;
inferring from the presence or absence of the at least one tracer in the at least one sample that injected carbon dioxide is leaking from the carbon dioxide storage formation.

The method may comprise quantifying the amount of carbon dioxide leaking from the carbon dioxide storage formation and/or the amount of carbon dioxide present in the carbon dioxide storage formation. The method may comprise identifying the origin or position of the leak. The method may comprise identifying the origin or position of the leak using seismic data, geometric data, geological data, isotopic and/or time series of tracer sampling. The method may comprise identifying the origin or position of the leak based on type of tracer, model data and/or interpretation.

The storage formation may be configured to store carbon dioxide originating from two or more carbon dioxide injection sources. The method may comprise inferring from the presence of the at least one tracer in the at least one sample which carbon dioxide source injected the leaking carbon dioxide. The method may comprise quantifying the amount of carbon dioxide remaining in the storage formation based on measuring two or more tracers in the at least one sample wherein one of the two or more tracers is an isotope signature. The method may comprise characterising and/or identifying the source of a leak of carbon dioxide stored in a storage formation based on the characteristics of the at least one tracer and/or an isotope signature of carbon dioxide in the collected samples. The method may comprise collecting samples from one or more sampling locations. The method may comprise collecting samples at known sampling times. The method may comprise collecting a plurality of samples.

Embodiments of the fifth aspect of the invention may include one or more features of the first to fourth aspects of the invention or their embodiments, or vice versa.

According to a sixth aspect of the invention, there is provided a method of detecting a leak from a carbon dioxide storage formation;
wherein the storage formation comprises carbon dioxide from multiple sources;
wherein carbon dioxide injected by a first carbon dioxide source is associated with a first tracer and carbon dioxide inject by a second carbon dioxide source is associated with a second tracer;
the method comprising;
taking at least one sample from one or more sampling location;
measuring the concentration of the first and/or second tracer in the at least one sample;
inferring from the presence or absence of the first and/or second tracer in the sample whether injected carbon dioxide from the first and/or second carbon dioxide source is leaking from the carbon dioxide storage formation.

The method may comprise injecting a known amount of carbon dioxide from one or more of carbon dioxide sources into the storage formation. The method may comprise detecting the first and/or second tracer in the sample. The method may comprise measuring the concentration of the first and/or second tracer in the at least one sample as a function of the sampling times. The method may comprise identifying the source of the leak based on type of tracer in the at least one sample. The method may comprise quantifying the amount of carbon dioxide leaking from the underground carbon dioxide storage formation and/or the amount of carbon dioxide present in the underground carbon dioxide storage formation. The method may comprise identifying the origin or position of the leak. The method may comprise identifying the origin or position of the leak using seismic, geological data and/or time series of sampling. The method may comprise identifying the source of the leak using model data and/or interpretation. The method may comprise characterising and/or identifying the source of a leak of carbon dioxide stored in a storage formation based on the characteristics of the at least one tracer and/or an isotope signature of carbon dioxide in the collected samples.

Embodiments of the sixth aspect of the invention may include one or more features of the first to fifth aspects of the invention or their embodiments, or vice versa.

According to a seventh aspect of the invention, there is provided a method of detecting a leak in a carbon dioxide storage formation;
the method comprising:
providing a plurality of carbon dioxide sources;
associating each carbon dioxide source with at a distinctive tracer specific for each individual carbon dioxide source;
injecting a known amount of carbon dioxide from at least one of the carbon dioxide source into the storage formation;
taking at least one sample from one or more sampling location;
measuring the concentration of tracer in the at least one sample;
inferring from the presence or absence of the tracer in the sample a leak from the carbon dioxide storage formation.

The method may comprise injecting a known amount of carbon dioxide from two or more carbon dioxide sources into the storage formation. The method may comprise measuring the concentration one or more tracer in the at least one sample. The method May comprise quantifying the amount of injected carbon dioxide from each carbon dioxide source leaking from and/or stored in the storage formation. The method may comprise characterising and/or identifying the source of a leak of carbon dioxide stored in a storage formation based on the characteristics of the at least one tracer and/or an isotope signature of carbon dioxide in the collected samples.

Embodiments of the seventh aspect of the invention may include one or more features of the first to sixth aspects of the invention or their embodiments, or vice versa.

According to an eighth aspect of the invention, there is provided a method for determining a carbon credit value and/or a carbon quota offset value for carbon dioxide stored in a carbon dioxide storage formation;
the method comprising:
providing at least one carbon dioxide source;
associating at least one carbon dioxide source with at a distinctive tracer specific for the carbon dioxide source;
injecting a known amount of carbon dioxide from the at least one of the carbon dioxide source into the storage formation;
taking at least one sample from one or more sampling location;
measuring the concentration of tracer in the at least one sample;
inferring from the presence or absence of the tracer in the at least one sample a leak of the injected carbon dioxide from the carbon dioxide storage formation;
estimating a carbon credit value and/or carbon quota offset value depending on an estimated amount of carbon dioxide remaining in the storage formation.

The method may comprise inferring from the presence or absence of the tracer in the at least one sample a leak from the carbon dioxide storage formation. The method May comprise quantifying the amount of injected carbon dioxide remaining in the storage formation. The method may comprise quantifying the amount of injected carbon dioxide remaining in the storage formation based on the measured tracer concentration. The method may comprise quantifying the amount of carbon dioxide leaking from the storage formation based on the measured tracer concentration. The method may comprise identifying at least one naturally occurring tag in the carbon dioxide. The at least one naturally occurring tag may be an isotope. The method may comprise detecting and/or quantifying the quantity of carbon isotope in the at least one sample. The method May comprise establishing a carbon credit value depending on the amount of carbon dioxide injected into the underground storage formation. The method may comprise converting the amount of carbon dioxide remaining in the underground storage formation into a carbon emission reduction credit.

Embodiments of the eighth aspect of the invention may include one or more features of the first to seventh aspects of the invention or their embodiments, or vice versa.

According to a ninth aspect of the invention, there is provided a method for determining a carbon quota status of an oil and gas process;
the method comprising:
providing at least one source of carbon dioxide emitted during an oil and gas process; associating the carbon dioxide with at a tracer;
injecting the carbon dioxide into the storage formation;
taking at least one sample from one or more sampling location;
measuring the concentration of tracer in the at least one sample;
estimating the amount of injected carbon dioxide from the at least one carbon dioxide source remaining in the storage formation;
establishing a carbon quota value depending on the amount carbon dioxide remaining in the storage formation.

The method may comprise establishing a carbon quota value by computing a difference between a quota allowance available for the oil and gas process and the overall emission value. The method may comprise determining a surplus value or a deficit value of based on a calculated difference between the quota allowance and overall emission value. The overall emission value may be calculated by subtracting the amount of carbon dioxide remaining in the underground storage formation from the amount of carbon dioxide emissions produced.

Embodiments of the ninth aspect of the invention may include one or more features of the first to eighth aspects of the invention or their embodiments, or vice versa.

According to a tenth aspect of the invention, there is provided a system for estimating an amount of carbon dioxide stored in a storage formation;
comprising:
   at least one source of carbon dioxide with at least one tracer;
   at least one injection device configured to inject the at least one source of carbon dioxide into the storage formation;
   a sampling device for collecting at least one sample, and
   analysing equipment configured to detect the type of tracer and/or concentration of tracer in the at least one sample.

The at least one source of carbon dioxide may be associated with at least one tracer specific for the carbon dioxide source. The at least one injection device may be configured to inject carbon dioxide from the at least one source of carbon dioxide and the at least one tracer into the storage formation. The sampling device may be configured to collect at least one sample at known sampling times. The sampling device may be configured to collect samples at known sampling times The sampling device may be configured to collect samples for later analysis. The sampling device may be configured to analysis samples in real time. The system may comprise at least one processor configured to estimate the amount of injected carbon dioxide from the at least one carbon dioxide source stored in the underground storage formation. The system may comprise at least one model configured to calculate, based on the concentration of tracer and/or the sampling time the amount of carbon dioxide stored in the storage formation. The at least one processor May comprise the model. The at least one processor may be configured to perform at least one tracer flow simulation to generate a model tracer data set and compare the model tracer data set with a measurement data set to estimate an amount of carbon dioxide stored in an underground storage formation. The analysing equipment may be configured to detect and/or measure an isotope ratio signature of the carbon dioxide present in the at least one sample.

Embodiments of the tenth aspect of the invention may include one or more features of the first to ninth aspects of the invention or their embodiments, or vice versa.

According to an eleventh aspect of the invention, there is provided a method for determining a source of leaked carbon dioxide from a carbon dioxide storage formation;
the method comprising:
detecting the presence of at least one tracer in at least one sample collected from one or more sampling location;
inferring from the presence or absence of the at least one tracer in the at least one sample a leak from the carbon dioxide storage formation;
identifying the at least one tracer;
associating the identified at least one tracer with the carbon dioxide injection source assigned the identified tracer.

The method may comprise determining the source of injected carbon dioxide leaking from the storage formation. The method may comprise assigning at least one unique tracer to each carbon dioxide injection source. The method may comprise determining the entity responsible for storing the carbon dioxide in the reservoir. The method may comprise adjusting carbon credits and/or carbon quotas awarded to the source. The method May comprise quantifying the leak. The method may comprise adjusting carbon credits and/or carbon quotas awarded to the source based on the amount of carbon dioxide leaked from the storage formation. The method may comprise determining the source of the leak from the storage formation. The method may comprise determining a pathway from the storage formation to the sampling location.

Embodiments of the eleventh aspect of the invention may include one or more features of the first to tenth aspects of the invention or their embodiments, or vice versa.

According to a twelfth aspect of the invention, there is provided a method of estimating an amount of injected carbon dioxide stored in an underground storage formation;
the method comprising:
injecting carbon dioxide from at least one carbon dioxide source into the storage formation;
injecting at least one tracer associated with carbon dioxide from each carbon dioxide source into the storage formation;
collecting samples from one or more sampling locations;
measuring the amount of the at least one tracer in the samples; and analysing the concentration of the at least one tracer in the samples as a function of time to estimate the amount of injected carbon dioxide stored in the underground storage formation.

Embodiments of the twelfth aspect of the invention may include one or more features of the first to eleventh aspects of the invention or their embodiments, or vice versa.

According to a thirteenth aspect of the invention, there is provided a method of estimating an amount of injected carbon dioxide stored in an underground storage formation;
the method comprising:
injecting carbon dioxide from at least one carbon dioxide source into the storage formation;
injecting at least one tracer associated with carbon dioxide from each carbon dioxide source into the storage formation;
collecting samples from one or more sampling locations;
measuring the amount of the at least one tracer in the samples;
analysing the concentration of the at least one tracer in the samples;
calculating residence time distribution data for the at least one tracer in the underground storage formation; and
estimating the amount and/or volume of injected carbon dioxide stored in the underground storage formation.

Embodiments of the thirteenth aspect of the invention may include one or more features of the first to twelfth aspects of the invention or their embodiments, or vice versa.

According to a fourteenth aspect of the invention, there is provided a method of estimating an amount of injected carbon dioxide stored in an underground storage formation;
the method comprising:
injecting carbon dioxide from at least one carbon dioxide source into the storage formation;
injecting at least one tracer associated with carbon dioxide from each carbon dioxide source into the storage formation;
collecting samples from one or more sampling locations;
measuring the amount of the at least one tracer in samples;
creating a model of the underground storage formation and/or pathways of injected carbon dioxide;
analysing the concentration of the at least one tracer in the samples as a function of time; and
based on the concentration and sampling time estimating the amount and/or volume of injected carbon dioxide stored in the underground storage formation using the model.

Embodiments of the fourteenth aspect of the invention may include one or more features of the first to thirteenth aspects of the invention or their embodiments, or vice versa.

According to a fifteenth aspect of the invention, there is provided a method of estimating an amount of injected carbon dioxide stored in an underground storage formation;
wherein the storage formation comprises carbon dioxide from at least one carbon dioxide source injected into the storage formation; wherein the carbon dioxide from each carbon dioxide source into the storage formation is associated with at least one tracer;
analysing samples previously collected at one or more sampling locations;
measuring the amount of the at least one tracer in the samples;
analysing the concentration the at least one tracer in the samples as a function of time;
and estimating the amount of injected carbon dioxide from the at least one carbon dioxide source stored in the underground storage formation.

The method may comprise inferring from the presence or absence of the at least one tracer in the sample a leak of the injected carbon dioxide from the at least one carbon dioxide source from the storage formation. The method may comprise creating a model of the underground storage formation and/or pathways of injected carbon dioxide. The method may comprise creating a model of the carbon dioxide injection and/or tracer injection. The model may comprise parameters selected from the group comprising seismic data, geological data, reservoir geometry, core data, log data, reservoir and/or pathways of injected carbon dioxide, modelled migration pathways, rock mechanics, temperature, pressure, gravity, density, viscosity; reservoir permeability, reservoir heterogeneities, solubility, fluid chemistry; porosity, fluid saturation, modelled tracer and carbon dioxide injection including tracer and carbon dioxide amounts, volumes and injection rates, injection locations, leakage locations, arrival time, residence time distribution, physical behaviour of CO₂ and/or chemical behaviour of CO. The method may comprise simulating characteristics of the reservoir and/or pathways of injected carbon dioxide and at least one tracer, and comparing modelled tracer sample data to measured tracer sample data. The method may comprise adjusting one or more parameters of the model to calibrate the modelled tracer sample data to the measured tracer sample data. The method may be a computer-implemented method. The method may be a computer-implemented history matching method. The method may comprise storing the measurement data to a database. The method may comprise storing the model data to a database. The detection and/or analysis of tracer in the samples a separate method to the injection of tracer and carbon dioxide and/or the collection of one of more samples. Samples may be collected and the tracer detected and analysed at a time or jurisdiction which is separate and distinct from the location of storage reservoir and therefore the collection of the samples.

Embodiments of the fifteenth aspect of the invention may include one or more features of the first to fourteenth aspects of the invention or their embodiments, or vice versa.

According to a sixteenth aspect of the invention, there is provided a method for determining a carbon credit value and/or a carbon quota offset value for carbon dioxide in a carbon dioxide storage formation; wherein the storage formation comprises carbon dioxide from at least one carbon dioxide source injected into the storage formation;
wherein the carbon dioxide from each carbon dioxide source into the storage formation is associated with at least one tracer;
analysing samples previously collected at one or more sampling locations;
measuring the concentration of tracer in the samples;
inferring from the presence or absence of the tracer in the samples a leak of the injected carbon dioxide from the carbon dioxide storage formation;
estimating a carbon credit value and/or carbon quota offset value depending on an estimated amount of carbon dioxide remaining in the storage formation.

The method may comprise quantifying the amount of injected carbon dioxide from each source remaining in the storage formation.

Embodiments of the sixteenth aspect of the invention may include one or more features of the first to fifteenth aspects of the invention or their embodiments, or vice versa.

According to a seventeenth aspect of the invention, there is provided a method of collecting samples for later analysis in estimating an amount of injected carbon dioxide stored in a storage formation; wherein the storage formation comprises carbon dioxide from at least one carbon dioxide source injected into the storage formation; wherein the carbon dioxide from each carbon dioxide source into the storage formation is associated with at least one tracer, the method comprising:
collecting at least one sample from one or more sampling location.

The method may comprise arranging sampling equipment at one or more sampling locations. The method may comprise collecting at least one sample from one or more sampling location before carbon dioxide and tracer is injected into the storage formation. The method may comprise collecting at least one sample from one or more sampling location during and/or after carbon dioxide and tracer is injected into the storage formation. The method may comprise collecting samples at known sampling times.

Embodiments of the seventeenth aspect of the invention may include one or more features of the first to sixteenth aspects of the invention or their embodiments, or vice versa.

### BRIEF DESCRIPTION OF THE DRAWINGS

There will now be described, by way of example only, various embodiments of the invention with reference to the drawings, of which:

FIG. 1 is a simplified sectional diagram showing a carbon dioxide storage system for obtaining carbon credits in accordance with an aspect of the invention;

FIG. 2 is a simplified sectional diagram showing a carbon dioxide storage system for carbon offsetting in accordance with another aspect of the invention;

FIG. 3 is a simplified sectional diagram showing a carbon dioxide storage system in accordance with a further aspect of the invention;

FIGS. 4A and 4B are a simplified plan views of a carbon dioxide storage leak detection system showing leak results at injection day 1 and injection day 100 respectively.

FIG. 5 is a flow chart showing steps to quantify carbon dioxide leaking from a reservoir based on the detection of tracer in a sample;

FIG. 6 is a flow chart for determining whether carbon dioxide is leaking from a storage formation based on the detection of tracer.

FIG. 7 is a simplified sectional diagram showing a carbon dioxide storage system with one injection well and one production well;

FIG. 8 is a simplified sectional diagram showing a carbon dioxide storage system with three injection wells and one production well;

FIGS. 9A and 9B is a simplified sectional diagram showing a carbon dioxide storage system showing possible tracer distribution paths from an injector to a leak location;

FIG. 10 is a flow chart showing steps to quantify carbon dioxide stored in a storage reservoir based on the detection of tracer in a sample;

FIG. 11 is a simplified sectional diagram showing a carbon dioxide storage system showing two injector wells to a leak location; and

FIG. 12 a simplified sectional diagram showing a carbon dioxide storage system showing possible carbon dioxide and tracer plume paths from an injector to a leak location.

### DETAILED DESCRIPTION OF PREFERRED EMBODIMENTS

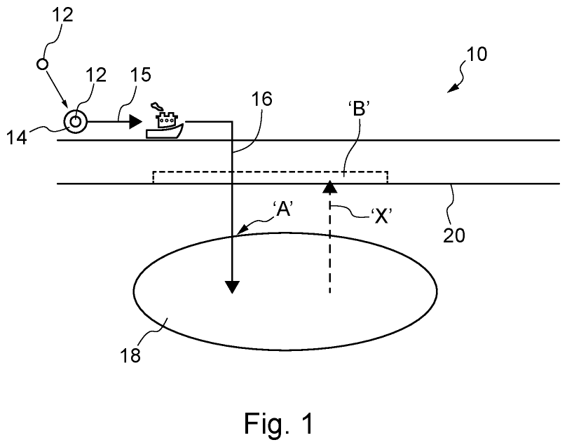

FIG. 1 is a simplified section of a carbon dioxide storage system according to the invention shown generally as 10. Carbon dioxide 12 is separated and captured from emissions of industrial processes or from the atmosphere. The captured carbon dioxide 12 is associated with at least one tracer 14. In this example a chemical tracer is used. However other tracer types including but not limited to fluorescent, phosphorescent, DNA, and radioactive compounds may be used. The tracer may comprise carbon dioxide molecules containing an isotope composition that distinguish them from carbon dioxide from other sources. The isotope composition or isotopic signature of the carbon dioxide may additionally or alternatively be used as a tracer. In this example a chemical tracer is used to label the carbon dioxide. However, it will be appreciated that the tracer may alternatively be tagged, mixed, infused or co-injecting with the carbon dioxide. The tracer may be carried by the carbon dioxide. The captured carbon dioxide 12 is transported shown as 15, and injected shown as 16 into a storage location. In this example the storage location is an offshore subsurface oil and gas reservoir 18. However, the storage location may alternatively be located onshore. The storage location may alternatively be any suitable location including saline formations, abandoned coal seams, organic-rich shales or basalt formations. It will be appreciated that the carbon dioxide may be associated with the tracer onsite.

The carbon dioxide and associated tracer is injected into the reservoir via an injection zone “A” connected to the reservoir. The rate of injection is measured volumetrically and/or by mass flow rate with a flow measurement device. The injected CO₂ is measured on a regular basis to determine flow rate. After injection, the injection zone “A” may be sealed.

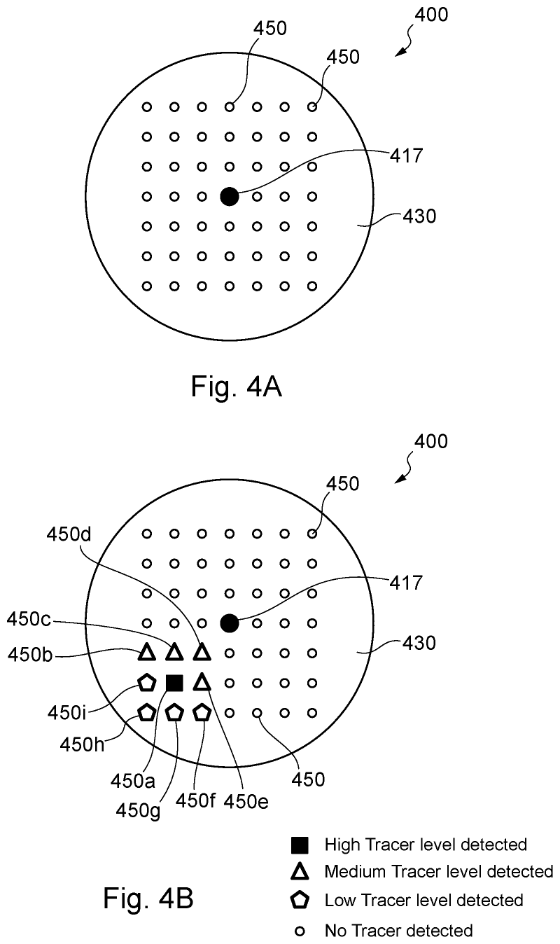

An area of seabed 20 shown as “B” in FIG. 1 which is above the reservoir and/or production wells (not shown) connected to the reservoir are monitored and samples taken to determine the presence or absence of the tracer. It will be appreciated that if the storage location is onshore the land surface above the reservoir, observation wells or any production wells connected to the reservoir may be monitored. This is further described in FIGS. 4A and 4B. In the event that tracer leaks or returns to the surface shown as arrow “X” in FIG. 1, the tracer is detected and the concentration of tracer and/or the transport time may be used for assessing CO₂ permanently stored in the reservoir. A model may be used to accurately determine upper and lower carbon dioxide levels in the reservoir. By determining the concentration of tracer in the sample and the sampling times the level of carbon dioxide stored in the reservoir may be calculated and a carbon credit value may be determined using the formula:

$${Carbon}_{STORED} = {CO}_{2 INJECTED} - {CO}_{2 LEAKED}$$

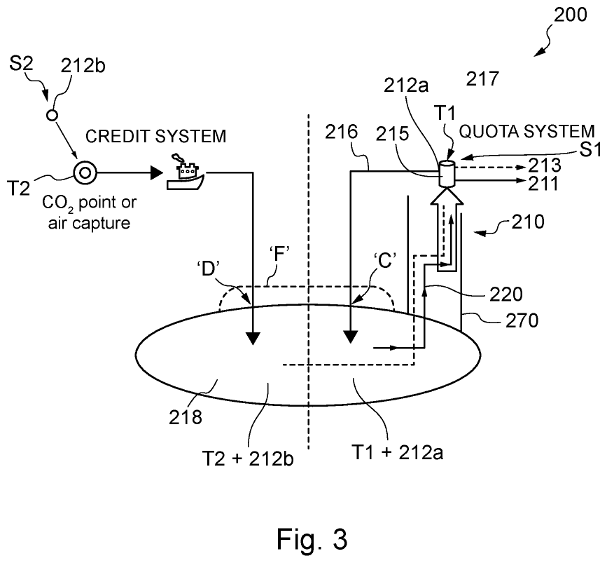

In this example the system is used in a carbon storage method for carbon credit. However it will be appreciated that this carbon storage system may be used simultaneously while hydrocarbons are extracted such as described in FIG. 3 below.

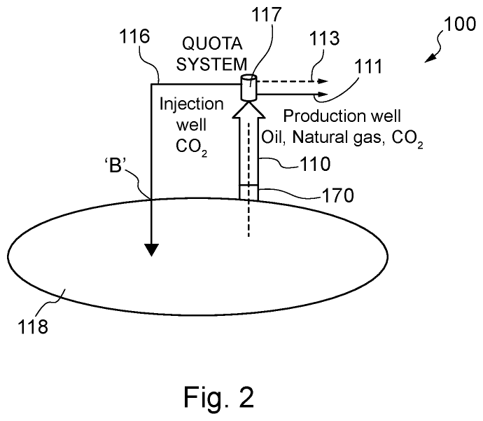

FIG. 2 is a simplified section of a carbon dioxide storage system according to the invention shown generally as 100 used in a carbon quota application. During oil and gas operations 110 hydrocarbons are produced shown as 111. In addition high levels of emissions including carbon dioxide are produced. Some of the produced carbon dioxide is utilised in chemical reactions into materials, chemicals and fuels shown as 113 in FIG. 2. In order to minimise the remaining carbon dioxide being released into the atmosphere and impacting an operators' carbon emissions quota, carbon dioxide is captured before entering the atmosphere and injected into a reservoir 118 shown as 116.

Before the carbon dioxide is injected into the reservoir 118 the captured carbon dioxide is associated with at least one tracer 117. In this example a chemical tracer is used to label the carbon dioxide. However other tracer types including fluorescent, phosphorescent, DNA, isotopic signature and radioactive materials may be used. The tracer may be a naturally occurring isotope of a component of carbon dioxide. Optionally bottomhole samples are taken across the reservoir and/or a surface samples to determine the occurrence of natural carbon dioxide in the reservoir and to create a baseline of naturally occurring carbon dioxide in the reservoir and/or surface sampling points. The carbon dioxide and associated tracer is injected into the reservoir via an injection zone “B” shown in FIG. 2 connected to the reservoir. The rate of injection is measured volumetrically and/or by mass flow rate with a flow measurement device. The injected CO₂ is measured on a regular basis to determine flow rate. After injection, the injection zone “B” may be sealed. Over time, the injected CO₂ may start migrating towards producing well 170. Regular samples are taken at the producing well. The samples may be taken downhole and/or at surface. The detection of the tracer, the concentration of tracer and/or the transport time may be used for assessing CO₂ volumes produced back and the CO₂ volumes stored in the reservoir. A model may be used to accurately determine upper and lower carbon dioxide levels in the reservoir. By determining the level of tracer and therefore the associated level of carbon dioxide produced back a carbon quota value may be determined using the formula:

$$Quota = {Carbon}_{initially produced} - ( {CO}_{2 injected} - {CO}_{2 produced back} ) .$$

Samples may be taken in the surrounding area to monitor for the presence of tracer and leaked carbon dioxide. This provides an understanding of the level of carbon dioxide stored in the reservoir.

$${Carbon}_{STORED} = {CO}_{2 INJECTED} - ( {CO}_{2 LEAKED} + CO {2}_{produced back} )$$

Captured CO₂ being injected and then back produced should be exempt from carbon tax (quota system) but may result in financial loss of carbon credits.

FIG. 3 is a simplified section of a carbon dioxide storage system 200 according to the invention used in an enhanced oil recovery application. The system 200 is similar to the systems 10 and 100 and will be understood from FIGS. 1 and 2 above. As shown in FIG. 3, carbon dioxide to be injected into the reservoir originates from two different sources S1, S2.

A first source S1 of carbon dioxide is from carbon dioxide captured during an oil and gas operation or process. A second source S2 of carbon is from carbon dioxide extracted from the atmosphere. As understood from the description of FIG. 2, during oil and gas operations 210 large volumes of carbon dioxide is emitted as well as produced hydrocarbons 211. The released carbon dioxide 212a is captured by a carbon capture system and injected 216 into an oil and gas reservoir 218. Injection of the captured carbon dioxide into the reservoir has two key benefits. First of all carbon emission to the atmosphere is mitigated which may facilitate the operator conducting oil and gas operations within an allowed carbon quota. Secondly the injected carbon dioxide may enhance oil production. The carbon dioxide may dissolve in the oil which may reduce oil viscosity and surface tension and cause the oil to swell which may improve oil recovery. In this example only carbon dioxide is shown injected into the reservoir. Carbon dioxide May be injected with steam or other fluid simultaneously or sequentially. The carbon dioxide 212a is injected shown as 216 into the reservoir 218 from which hydrocarbons may be simultaneously extracted 220 via the production well 270.

In this example samples are taken across the reservoir and/or at surface to determine the occurrence of natural CO₂ in the reservoir and to create a baseline of naturally occurring carbon dioxide in the reservoir 220 and/or surface sampling points. This sampling may include measuring a carbon-12/carbon-14 isotope ratio signature. The gas mixture in the reservoir is typically free of, or has lower concentration than, cosmogenic induced isotopes (e.g. Carbon-14) than the surrounding ambient air.

The isotope ratio signature will depend on the source of carbon dioxide. Carbon dioxide from “new” biomaterial or direct air capture (DAC) will have a direct measurable content of carbon-14 while carbon originating in oil reservoirs may have almost no carbon-14. The isotope ratio signature of noble gases may vary between sources, and concentration May also be modified by the CO₂ capture technique used. The tracer monitoring technique may include a systematic assessment of the background level of many markers in the reservoir, at sampling points and/or in the injected CO₂. Before injection into the reservoir, captured carbon dioxide from source S1 is labelled with a first tracer type. In this example the first tracer type is a chemical tracer T1. The carbon dioxide and tracer is injected into the reservoir via an injection zone “C” connected to the reservoir. Injection of the carbon dioxide and tracer T1 can be carried out either by continuous injection or by pulse injection. The rate of injection is measured volumetrically and/or by mass flow rate with a flow measurement device. The injected CO₂ is measured on a regular basis to determine flow rate. Before injection, samples from the reservoir, production stream and/or at surface may be taken to confirm the absence of the tracer in the reservoir, production stream and/or at surface before injection. Over time the injected CO₂ 212a and tracer T1 may start migrating towards the producing well 270. Samples are taken at the producing well. Sampling may be taken at known sampling times. Sampling may occur downhole and/or at surface. Samples collected, either from observation wells, production wells or from surface sampling points will be analysed for tracer T1.

FIG. 3 also shows a carbon credit system where a second source (S2) of carbon dioxide 212b is to be stored in the reservoir 218. The source of the carbon dioxide 212b in this example is captured from emissions of industrial processes or from the atmosphere. The carbon dioxide 212b may be captured by a private individual or company and stored in the reservoir. The captured carbon dioxide 212b is tagged with at a second tracer type T2. In this example the second chemical tracer T2 is distinguishable from the first chemical tracer T1. The carbon dioxide 212b and associated tracer T2 is injected into the reservoir via an injection zone “D” connected to the reservoir. The rate of injection is measured volumetrically and/or by mass flow rate with a flow measurement device. The injected CO₂ is measured on a regular basis to determine flow rate. After injection, the injection zone “D” may be sealed.

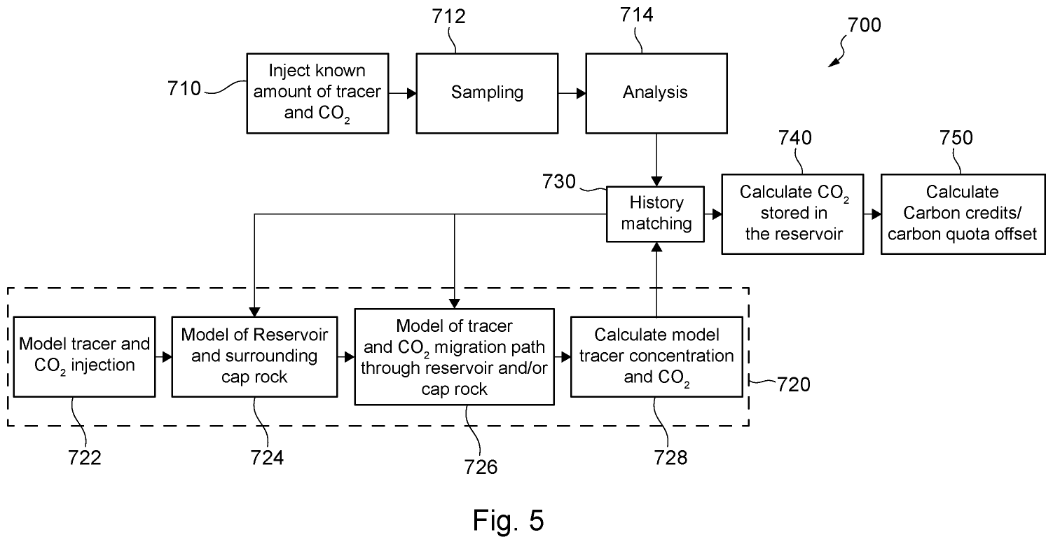

Samples may be taken from the surrounding area shown as “F” in FIGS. 3 and/or production well 270 connected to the reservoir to determine the presence of the first tracer T1 and/or second tracer T2. The detection of the tracers, the concentration of tracers and/or the transport time may be used for assessing CO₂ volumes produced back and the CO₂ volumes stored in the reservoir from each CO₂ injection source. Analysis techniques may be based on chromatographic separation followed by mass spectroscopic methods allowing quantification of tracer concentrations down to parts per trillion level. Quantification of CO₂ volumes may be based on tracer dilution and/or arrival time measurements. Quantification of CO₂ volumes may be based on data from monitoring techniques including but not limited to 3D (4D) seismic, well logging tools, gravimetry, residence time distribution and/or production data. The detection of the tracer type, the concentration of tracer and the transport time may be used for assessing CO₂ volumes permanently stored in the reservoir. A model, discussed further in relation to FIG. 5 may be used to accurately determine upper and lower carbon dioxide levels stored in the reservoir. The amount of carbon dioxide back produced via production is accurately calculated and used to calculate how much carbon dioxide is stored in the reservoir and whether the quota system awarded to Source S1 is in excess or deficit.

$$Quota Level = Quota allowance - ( {CO}_{2 initially produced} - ( {CO}_{2 injected at zone “ C} ” - {CO}_{2 back produced} ) ) .$$

A centralised authority sets the carbon dioxide quota allowance. The carbon dioxide produced is injected into the reservoir to mitigate the impact of the emissions on the carbon quota. If the amount of carbon injected exceeds the overall amount of carbon emitted then the operator S1 may have a quota excess which they may sell or trade to other operators or industries. It is also important to keep track of whether carbon emissions originate from previous injected carbon dioxide or are new sources of carbon dioxide. Captured carbon dioxide being injected and then back produced should be exempt from carbon tax (Quota System). However if the carbon dioxide is back produced from injection it should result in a loss of carbon credits. Therefore it is important that the amount of carbon dioxide injected and stored is quantifiable. The use of tracers may be used to track each carbon offset instrument of the quota and credit systems. By determining the level of the second tracer T2 and therefore the level of carbon dioxide stored in the reservoir a carbon credit value may be awarded to source S2 determined using the formula:

$$Carbon stored = {CO}_{2} injected via zone “ D ” - {CO}_{2} amount back produced or leaked .$$

The amount of carbon dioxide injected and stored is converted to carbon credits which is a tradeable asset. Therefore it is important that the amount of carbon dioxide injected and stored is quantifiable.

The use of distinctive tracers T1 and T2 may facilitate the tracking of CO₂ injected and confirm permanent storage into the reservoir from the various sources S1 and S2. This may allow accurate allocation of carbon credit and/or adjustment of quota systems. The distinctive tracers may allow accounting for individual volumes either as a function of specific time intervals or based on specific injection points. Tracers, either natural or artificial can contribute to accounting for the storage or back production of the different injection volumes. Adding of a unique tracer pulse in each injection wells may facilitate quantifying of back production of CO₂. Integration of the tracer production curve will give a direct measurement of how much tracer is produced which, compared to how much was injected, will give the fraction of the particular injected CO₂ volume which is not stored permanently.

Additionally or alternatively an isotopic ratio signature of carbon dioxide from a carbon dioxide injection source may be used as a tracer. As an example the carbon dioxide from S1 may have a unique Carbon 14 isotope signature which can be measured by various techniques such as gas proportional counting, liquid scintillation counting, and/or mass spectrometry and may allow precise measurement of mixtures of naturally occurring isotopes. Initial baseline measurements may show the reservoir has no C14 isotope present prior to injection. The isotope ratio data of the injected and measured samples may be used to quantify leakage. If carbon dioxide from S1 having a natural presence of the isotope C14 at 1 ppt is injected into the reservoir via zone C at a rate of 1 ton/day and the production well is producing 2 tonnes/day of carbon dioxide with a concentration of 0.01 ppt. The injected carbon dioxide is being back produced at a rate of 20 kg/day (based on 2 Ton/day×0.01 ppt/1 ppt). In this example the identification of the tracer T1 and/or isotope ratio signature for S1 may identify the source of the carbon dioxide as S1, as S1 and S2 have unique tracer types and/or isotope ratio signatures. As carbon dioxide from injection source S1 has not permanently been stored any carbon credits allocated to S1 is adjusted or withdrawn.

FIGS. 4A and 4B are simplified plan views of a carbon storage leak detection system 400 with an injection well 417 passing through cap rock 430 such that the injection well 417 is in communication with a storage reservoir (not shown). Numerous observation wells 450 are arranged in the caprock surrounding the injection well 417 in known locations. In this example 48 observations wells are arranged in a grid pattern around the injection well 417. It will be appreciated that a different number of observations wells in an alternative arrangement may be used. Carbon dioxide and tracer is injected via the injector well 417 into the reservoir. The injection rate of carbon dioxide in this example is 10 tonnes/day and 1 gram/day of tracer. Each of the observation wells are monitored for the presence of the injected tracer. In this example each well comprise at least one tracer absorption measuring device designed to absorb and accumulate any tracer present in the observation well. Carbon dioxide and associated tracer injected in a subsurface reservoir may leak to the surface by migrating through the cap rock. Tracers that follow the carbon dioxide through the migration path may contain information about leakage flow rates and amount of carbon dioxide escaping from the storage reservoir.

FIG. 4A shows that samples taken from the observation wells on Day 1 of injection show that no tracer was absorbed and detected in any of the observation wells 450 indicating that no carbon dioxide and tracer was released from the reservoir storage.

FIG. 4B shows the tracer absorption detection results on Day 100 after a total of 1000 tonnes of carbon dioxide and 1 kg of tracer has been injected into the reservoir. Tracer absorbed over the 100 days in well 450a amounts to 1 g. The surrounding wells 450b, 450c, 450d and 450e each have 0.5 g of tracer absorbed. Wells 450f, 450g, 450h and 450i have a lower tracer level of 0.1 g of tracer detected over the 100 days. The remaining wells 450 in the grid have no tracer material detected.

On Day 100 of injection a total of 2.4 grams of tracer has been accumulated by absorption and detected which corresponds to a leak of 2.4 tonnes of injected carbon dioxide from the reservoir. Further analysis such as linear regressions, stochastic modelling between observation wells as well as empirical data on absorption efficiency may further improve quantification. Combining accumulated mass measured tracer data with data from background samples collected prior to injection may allow the injected carbon dioxide to be identified from other sources including naturally occurring carbon dioxide. Samples collected from observations wells, from the seabed and/or surface may contain carbon dioxide from the reservoir and/or from the air or from a young subsurface formation in the volume between the storage reservoir and the surface.

Detection of tracers in the samples may verify leakage from the reservoir. By combining tracer concentration in samples, mathematical models of the storage reservoir and/or cap rock a quantification of CO₂ released and stored may be estimated. The method May determine whether the leak affects all sections of the reservoir and/or the degree of exposure of injected carbon dioxide to the leak location. The model may comprise a simulation of tracer/carbon dioxide transport in the reservoir and/or cap rock. Collecting multiple samples from different sampling points, and combination of different tracers May increase the accuracy of the quantification. Although FIGS. 4A and 4B describe quantification of carbon dioxide from a leak through the cap rock, this method may be used in combination with, or alternatively to, the quantification of carbon dioxide back produced from a producing well to determine the amount of carbon dioxide stored in the reservoir.

FIG. 5 shows a flow chart 700 for quantifying carbon dioxide leaking from a reservoir and carbon dioxide stored in the reservoir based on the detection of tracer in the collected samples. In a first step 710 a known amount of tracer and carbon dioxide is injected into the reservoir over a known period of time. Samples are collected at step 712 at known times in at least one known sampling location. The at least one sampling location in this example is an observation well. It will be appreciated that the at least one sampling location may alternatively or additionally be a production well, areas of the seabed, land surface or any other place where an adequate sampling point is accessible. At step 714 the samples are analysed. In this example the analysis step includes measuring the tracer concentration in the samples. The measured data is compared with a model 720 shown in a dotted box in FIG. 5.

The analysis of tracer in a collected sample may be a separate method to the collection of samples. Samples may be analysed at a time or jurisdiction which is separate and distinct from the sampling location and the collection of the samples. In this example the model 720 includes modelled tracer and carbon dioxide injection 722 including tracer and carbon dioxide amounts, volumes and injection rates. The model data may include a model of the reservoir and the cap rock 724. The model data may include a modelled migration path of the tracer and carbon dioxide through the reservoir and/or cap rock 726. Based on numerical simulation of carbon dioxide and tracer flow a modelled tracer concentration as function of time is calculated at the modelled sampling point 728. The modelled tracer concentration 728 is compared with the measured tracer concentration data. If the model simulation does not match the observed tracer concentration, the model is tuned to match observed tracer concentration using history matching 730. Once the model is calibrated and refined to best match to the observed measured data then the amount of tracer and corresponding carbon dioxide released from the reservoir may be quantified. Optionally the amount of carbon dioxide remaining in the reservoir may be calculated in step 740 based on the amount that has leaked from the reservoir. The model may be used to determine the distribution of injected tracer and carbon dioxide in the reservoir and the impact of a leak on the amount of stored carbon dioxide. Optionally accurate calculation of carbon credit and/or carbon quota offsets may be calculated in step 750 based on the amount of carbon dioxide stored.

The history matched model may contain information about how much carbon dioxide is stored and how much carbon dioxide is leaking out of the reservoir. The simulation model may calculate how this changes over time. The above example describes modelling of one tracer, one carbon dioxide source, one injection point and one sampling point. It will be appreciated that the model may be adjusted for multiple tracers, multiple carbon dioxide sources, multiple injection points and/or multiple sampling points. It will be appreciated that the operational steps described above in relation to FIG. 5 are examples of the invention and that one or more steps may be omitted or added and/or that the sequence of the steps may be different and/or steps may overlap in time. It will be appreciated that the samples of the carbon dioxide to be quantified may leak through the cap rock. This method may be used in combination with, or alternatively to quantify carbon dioxide back produced from a producing well to determine the amount of carbon dioxide stored in the reservoir. It will be appreciated that the model of the reservoir and/or pathways of injected carbon dioxide may include parameters selected from the group comprising: seismic data, geological data, reservoir geometry, core data, log data, reservoir and/or pathways of injected carbon dioxide, modelled migration pathways, rock mechanics, temperature, pressure, gravity, density, viscosity; reservoir permeability, reservoir heterogeneities, solubility, fluid chemistry; porosity, fluid saturation, modelled tracer and carbon dioxide injection including tracer and carbon dioxide amounts, volumes and injection rates, injection locations, leakage locations, arrival time, residence time distribution, physical behaviour of CO₂ and/or chemical behaviour of CO₂.

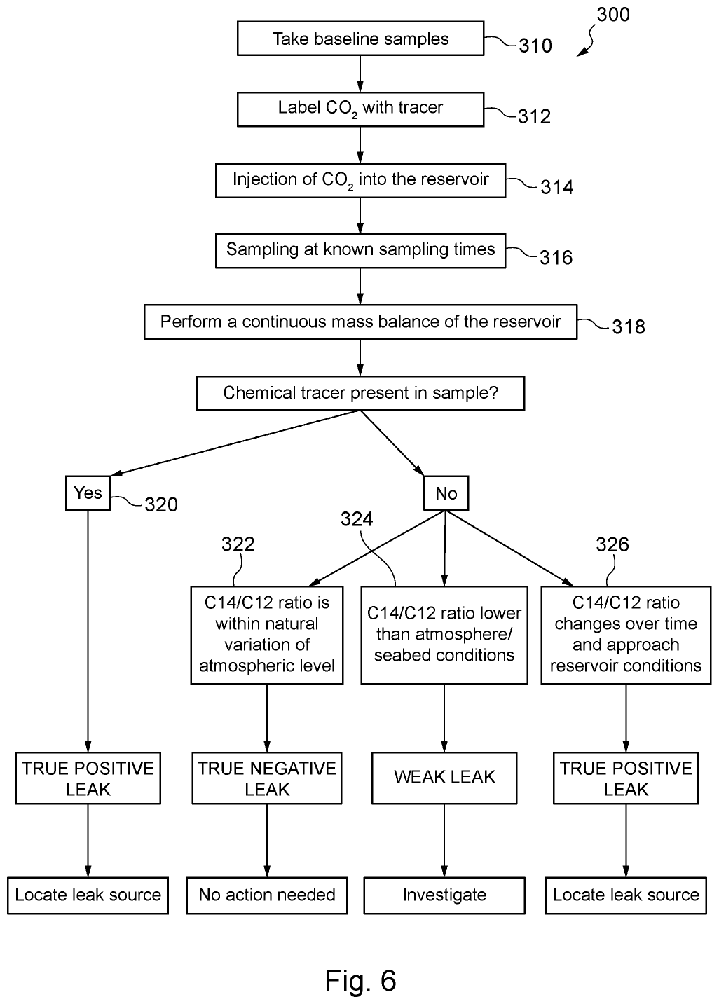

FIG. 6 shows a flow chart 300 for determining whether carbon dioxide is leaking from a reservoir based on the detection of tracer in a sample.

As a first step 310 samples are taken across the reservoir and/or a surface samples to determine the occurrence of natural CO₂ in the reservoir to create a baseline of naturally occurring carbon dioxide in the reservoir and/or surface sampling points. This sampling may include measuring a carbon-12/carbon-14 isotope ratio signature. In a second step captured carbon dioxide is labelled with a known tracer type that is not present in the reservoir. Different tracer may be used, dependent on the source or location of the carbon dioxide injection. Different tracers may also be used depending on whether the injected CO₂ is regulated by a quota system or a carbon credit system.

When a reservoir composition baseline has been created in step 310 the carbon dioxide and associated tracer is injected into the reservoir via an injection zone connected to the reservoir shown in Step 314. The rate of injection is measured volumetrically and/or by mass flow rate with a flow measurement device. The injected CO₂ is measured on a regular basis to determine flow rate, chemical composition including the presence of specific isotope ratios. In this example the isotopes are C14/C12. However, it will be appreciated that other isotopes may be monitored. The tracer follows the injected CO₂ front in the reservoir. Over time, the injected CO₂ may start migrating towards the production well. In step 316 sampling is conducted at known sampling times. In this example samples are taken from a production well in fluid communication with the reservoir. Additionally or alternatively, areas of the seabed, land surface or observation wells or any other place where an adequate sampling point is accessible may be monitored for presence of hydrocarbons, chemical tracers and isotope ratios of selected element. The recovery of tracer, its concentration and/or the transport time may be used for assessing CO₂ volumes permanently stored in the reservoir.

The method may comprise establishing a tracer concentration curves. The curve may be integrated to give the mass of tracer produced. The mass of tracer produced will be a certain fraction of the mass of tracer injected. The same fraction will be the fraction of CO₂ volume injected from the particular source and the volume of CO₂ produced and thereby not permanently stored in the actual reservoir. In step 318 a continuous mass balance of the reservoir is performed to establish upper and lower limits for CO₂ and tracer (and/or isotope) data present in the reservoir. This may involve starting with the original conditions and adding the CO₂ composition injected. Local variations can occur dependent on reservoir permeability, reservoir heterogeneities and fluid chemistry. As such, a reservoir simulator may be used to establish an upper and lower concentration at various locations in the reservoir. In step 320 if the tracer is detected in a sample, then carbon dioxide is leaking from the reservoir to the surface. This may be as a result of human activity such as oil production. The leak needs to be localized and quantified, using various methods including but not limited to tracer arrival time, seismic interpretation, and time series of sampling.

Optionally isotope data of collected carbon dioxide may be analysed. If the tracer is not detected there are three options shown as steps 322, 324 and 326 respectively. A first option 322 is that no chemical tracer is present in the sample and an analysis of carbon isotope data is that the Carbon-14/Carbon-12 ratio is within natural variation of atmospheric level, the same as the initial baseline. This indicates that there is not a leak from the reservoir to the surface, but CO₂ originates from younger deposits located higher up in the geological structure above the cap rock. No action is required. A second option 324 is that there is that no chemical tracer is present in the sample and an analysis of carbon isotope data is that the Carbon-14/Carbon-12 ratio at the observation point deviates from the initial baseline and is closer to the observed and calculated conditions in the reservoir, it is lower than atmosphere/seabed conditions. This may be evidence of a weak leak. There is some leakage from the reservoir to the surface. The leak can be naturally occurring seepage to the surface or caused by human activity. The activity causing the leak must be investigated using methods such as seismic interpretation, geological understanding and timeseries sampling. A third option 326 is that there is no chemical tracer present in the sample and an analysis of carbon isotope data is that the Carbon-14/Carbon-12 ratio changes over time approaching reservoir conditions. This May be evidence of a true positive leak. The CO₂ observed may originate from the reservoir but possibly not from a known injection source. The action is to locate the origin or position of the leak using seismic and geological data and time series of sampling to determine the source of the leak.

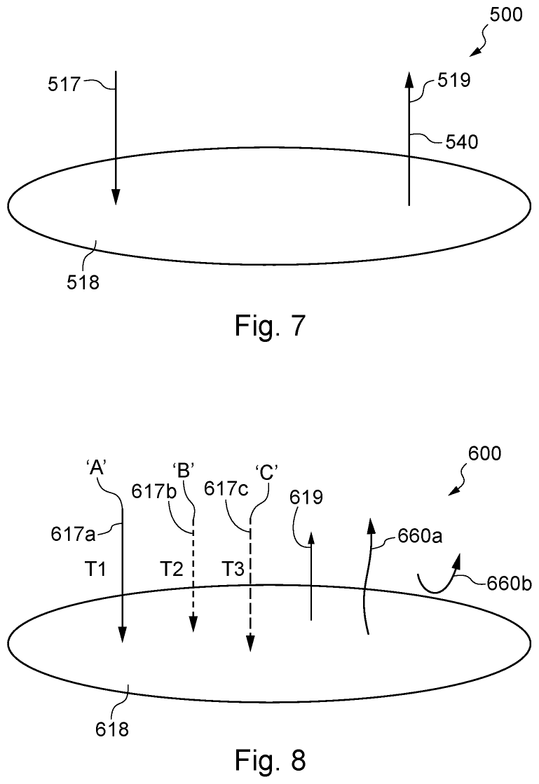

The method may comprise creating a model of the reservoir and/or pathways of injected carbon dioxide. The model parameters may include parameters selected from the group comprising seismic data, geological data, reservoir geometry, core data, log data, reservoir and/or pathways of injected carbon dioxide, modelled migration pathways, rock mechanics, temperature, pressure, gravity, density, viscosity; reservoir permeability, reservoir heterogeneities, solubility, fluid chemistry; porosity, fluid saturation, isotope data, modelled tracer and carbon dioxide injection including tracer and carbon dioxide amounts, volumes and injection rates, injection locations, leakage locations, modelled tracer arrival time, residence time distribution, physical behaviour of CO₂ and/or chemical behaviour of CO₂. The model may be updated based upon measured and/or calculated data. The reservoir model may employ history matching. History matching may use historical parameter measurements compared to calculated data. The parameters of the model May be adjusted until a reasonable match is achieved between the measured and calculated data. Injection of CO₂ into the storage formation may be carried out either through one injector well as described in FIG. 7 or through a multiple injector wells as described in FIG. 8. In a multi injector well system the CO₂ may be provided by the same or different sources.

FIG. 7 is a simplified schematic of a carbon dioxide storage system 500 with one injector well 517 and one producer well 519 in communication with reservoir 518. The carbon dioxide and associated tracer is injected via the injector well 517 into the reservoir 518. The injection may be a continuous tracer injection or a pulse injection. Over time one or more samples are collected in the production well. The amount of concentration of tracer in the collected samples is measured. By using tracer concentration and flow data in the production well the amount of carbon dioxide released from the reservoir is quantified and the amount of carbon dioxide which remains permanently stored in the reservoir may be estimated. In this example one sampling point 540 in the production well 519 is shown and both tracer concentration and flow rate are measured. A direct quantification of back produced tracer amount and quantification of carbon dioxide remaining in the reservoir can be achieved. In more complicated storage reservoirs, the tracer data may be integrated with other reservoir data and used for calibrating a subsurface storage model.

FIG. 8 is a simplified schematic of a carbon dioxide storage system 600 with three injector wells 617a, 617b and 617c and one producer well 619 in communication with reservoir 618. Carbon dioxide from a first source, company A, is labelled with tracer T1 and is injected via the injector well 617a into the reservoir 618. In this example the carbon dioxide is from air capture and is injected into the reservoir. Carbon dioxide from a second source, company B, is labelled with tracer T2 and is injected via the injector well 617b into the reservoir 618. In this example the captured carbon dioxide is from a pulverised coal (PC) power plant. The third carbon dioxide source, company C, is labelled with tracer T3 and is injected via the injector well 617c into the reservoir 618. In this example the carbon dioxide was previously produced from the reservoir and is being reinjected. Before injection, samples from the reservoir 618 and production well 619 are taken to establish baseline readings and to determine the reservoir and bottom conditions before injection. Optionally if reservoir leak detection is to be implemented in areas around the reservoir such as described in FIGS. 4A and 4B then samples are collected above and/or around the reservoir such as observation wells or locations on seabed and/or land surface to construct a baseline of carbon dioxide and/or isotope levels before injection. The labelled carbon dioxide is injected via injector wells 617a, 617b and 617c into the reservoir 618. Samples and flow measurement are taken at each injection well site to determine mass and composition. The rate of injection may be measured volumetrically and/or by mass flow rate with a flow measurement device. A mass balance may be performed by reservoir simulator or similar software to determine the carbon dioxide distribution in the reservoir at any given point in time. Reservoir production is sampled and analysed for tracer and optionally isotope ratios at regular intervals. The sampling times may be determined with authorities or certification agency. Optionally as shown as arrow 660a in FIG. 8, samples are collected after injection from locations above and/or around the reservoir such as observation wells or locations on seabed and/or land surface as described in FIGS. 4A and 4B to determine whether carbon dioxide is leaking from the reservoir via seepage through the cap rock or to ascertain whether naturally occurring carbon dioxide is present from younger deposits located higher up in the geological structure above the cap rock (arrow 660b).

In the event that no tracer is detected in production stream from the production well, and the isotope ratios on surface are constant then all injected carbon dioxide mass flow is stored in the reservoir and is counted towards carbon credits or quota offsets. In the event that tracer is detected in the production stream from the production well and/or the isotope ratios on surface are constant then stored carbon dioxide is leaking from the reservoir. The tracer type is determined to identify the source of the carbon dioxide. The amount of carbon dioxide released may be quantified based on the measured tracer concentration, arrival time of the tracer and/or sampling sequence. The data may be used to calibrate a model of the reservoir. The carbon credit or carbon quota offset awarded to the source of the leaked carbon dioxide may be adjusted based on the actual amount of carbon dioxide permanently stored. In the event that tracer is detected in a location outside the production well such as an observation site, seabed gas bubble and/or at surface, then carbon dioxide is leaking through the cap rock and/or formation. The tracer type is determined to identify the source of the carbon dioxide. The amount of carbon dioxide released and/or leak rate may be quantified based on the measured tracer concentration, arrival time of the tracer and/or sampling sequence. The data may be used to calibrate a model of the reservoir. This may facilitate the location and type of leak to be identified. Additionally or alternatively to the use of an artificial tracer, a natural tracer such as isotope ratio signature of carbon present in the sample may be observed over time. The amount of carbon dioxide released and/or leak rate may be quantified based on the amount of specific isotope ratio present in the sample compared with baseline readings and/or the amount of specific isotope ratio injected. The amount of carbon dioxide injected via injector well 617a into the reservoir 618 and the amount of tracer T1 detected in the the production stream and/or an observation site determines whether company A generates carbon credits. Similarly company B generates carbon credits determined by the amount of carbon dioxide injected via injector well 617b into the reservoir 618 and the amount of tracer T2 detected in the the production stream and/or an observation site. Company C re-injected carbon dioxide released during oil and gas production activities. The amount of carbon dioxide permanently stored in the reservoir is counted as a reduction in the overall carbon dioxide emitted during company C's oil and gas production activity under the carbon quota offset system. In the event that injected carbon dioxide is detected in the production well or leaked to another location, its origin from the different sources may be distinguished and identified by the unique natural and/or artificial tracer. The amount of tracer released from the reservoir may be quantified by the concentration of the tracer and/or measuring the natural occurring variations of trace elements or isotopic ratios.

By assigning a unique tracer to each of the different tracer sources companies A, B and C, information about the origin of the leakage or back produced carbon dioxide may be provided. This has the benefit of allowing accurate injection and permanent storage logs to be made and the detection of injected carbon dioxide leaking from the reservoir. This information may also enable the identification of the source of the injected carbon dioxide which is not permanently stored in the reservoir. This may facilitate an accurate credit/quota system being implemented where entities which successfully permanently store carbon dioxide in the reservoir are correctly allocated carbon credits or carbon quota offsets whereas entities that inject carbon dioxide which is subsequently leaked or back produced are not rewarded or previously allocated carbon credits or carbon quotas offsets withdrawn. This may ensure that only the injectors who have permanently stored carbon dioxide are rewarded carbon credits or carbon quota.

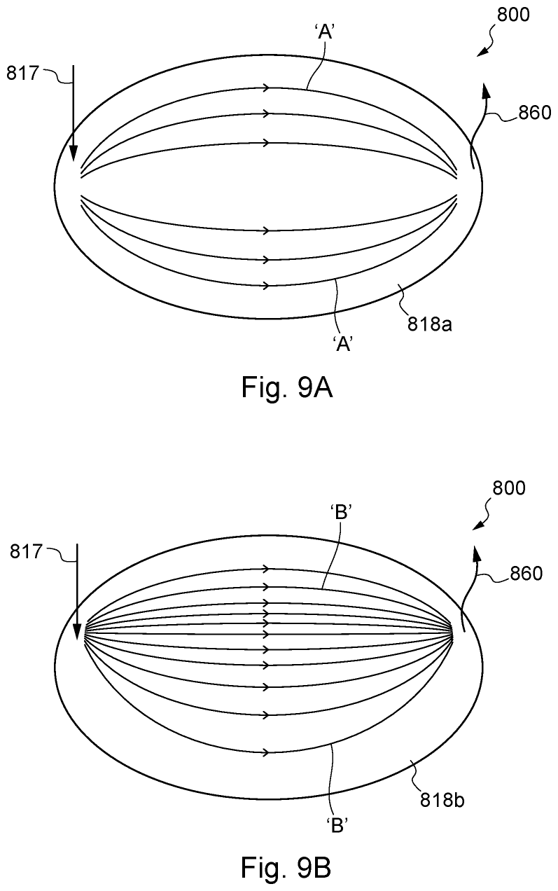

FIGS. 9A and 9B shows simplified schematic of a carbon dioxide storage system 800. In this example the system has one injector well. The tracer and carbon dioxide is injected into the storage reservoir 818a, 818b at a known injection rate and migrates through the reservoir. If there is a leak in the reservoir a Residence Time Distribution (RTD) may be used to quantify the tracer and associated carbon dioxide stored in the reservoir. Residence Time Distribution is the distribution of times used by a population of tracer particles to travel through a medium. The tracers represent elements of fluid that travel through different paths, and that therefore use different amounts of time to pass through a medium. Interpretation of tracer data by use of residence time distribution analysis may also be used to quantify sweep volume and the magnitude of connections in storage reservoir.

RTD analysis involves injecting the tracer and carbon dioxide at the injection site into a reservoir and measuring the tracer concentration as a function of time at the leakage location. This may be interpretated as a distribution of residence times for the tracers in the storage reservoir. The examples shown in FIGS. 9A and 9B are illustrations of two different tracer migration paths through two different reservoirs 818a, 818b. As shown in FIGS. 9A and 9B the tracer and carbon dioxide take different paths from the injectors 817 through the storage reservoirs to the leakage location 860 shown as arrows “A” in FIG. 9A and arrows “B” in FIG. 9B respectively. The time it takes to arrive at a leak location taking a specific path is denoted as the residence time for that particular path. For a collection of tracer particles injected, the different paths taken yields a distribution of residence times. The distribution of residence time is related to a concentration curve at the leakage location. The residence time distribution is affected by the flow. If a heterogeneity is present in the reservoir, it may enhance fluid velocity in part of the reservoir. In this example a heterogeneity is present in the reservoir 818b in FIG. 9B, as a result the distribution of the tracer in FIG. 9B will be shifted towards a smaller residence time. This will yield a smaller average residence time.

The distribution, E(t), of these times is called the residence time distribution. E(t) is defined from leaked tracer concentrations, C(t), leakage rate, Qₚ(t), and injected tracer amount, M, as:

$$E ( t ) = C ( t ) \cdot Qp ( t ) / M \qquad ( 1 )$$

The unit of E is the inverse of the time unit. Important information about the geometry and flow in a system can be obtained from moments of the residence time distribution. They are defined as:

$${m}_{n} = {\int }_{- ∞}^{∞} E ( t ) \cdot {t}^{n} ( t ) dt \qquad ( 2 )$$

The zero-order temporal moment of the residence time distributions (m₀=∫E(t)dt) give the fraction of tracer, originating from a given injector, leaked at the leakage site. The first order moment m₁=∫t·E(t)dt is related to average residence time ( [symbol] t [symbol] =m₁/m₀).

The swept pore volumes can be determined once the average residence time and the fraction of tracer leaked are known. For example the fraction m₀ corresponds with the amount of injected tracer and carbon dioxide that migrates to the leakage location. If m₀=0.20, this means that 20% of the injected tracer and carbon dioxide move towards the leakage site.

$${V}_{s} ≡ {Q}_{i} \overline{T} = {Q}_{i} {m}_{1} / {m}_{0} \qquad ( 3 )$$

The zero moment represents the relative amount of tracer leaked at the leak location and the first moment represents the average residence time for the tracers between the injection well and a leakage location. The tracer data can be analysed to assess the volumetric sweep to quantify the amount of tracer and carbon dioxide flowing from the injector to the leakage location. It gives an indication of magnitude of the injector-leakage location connection. The first order moment from a model can be compared to the first order moment from tracer data. These first order moments can be used to find swept volume from an injector to a leak location from data and model, which in turn can be illustrated as a volume or area of a given size.

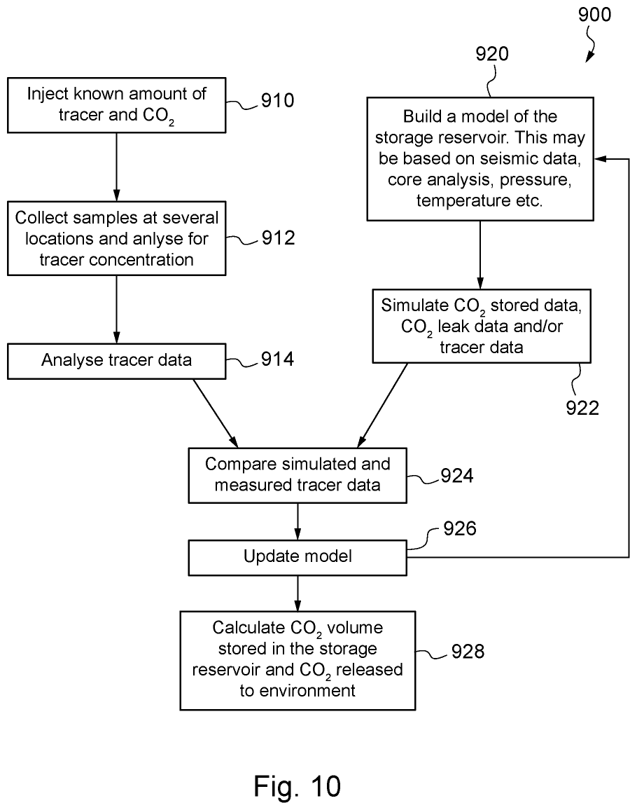

FIG. 10 shows a flow chart 900 for quantifying carbon dioxide stored in a storage reservoir based on the detection of tracer in collected samples. In a first step 910 a known amount of tracer and carbon dioxide is injected into the reservoir over a known period of time. Samples are collected at step 912 at known times in at known sampling locations. The sampling locations in this example are observation wells. It will be appreciated that the sampling locations may alternatively or additionally be a production well, areas of the seabed, land surface or any other place where an adequate sampling point is accessible. At step 914 the samples are analysed. In this example the analysis step includes measuring the arrival time of the tracer and the sampling time at the leakage location. A residence time distribution analysis may be conducted including calculating the fraction of tracer leaked versus tracer injected, calculating an average travel time from the injection location to the leakage location. The swept volume of the tracer in the storage reservoir may be calculated. The analysis of tracer in a collected sample may be a separate method to the collection of samples. Samples may be analysed at a time or jurisdiction which is separate and distinct from the sampling location and the collection of the samples.

A model 920 of the storage reservoir may be established based on data selected from the group comprising: seismic data, geological data, reservoir geometry, core data, log data, reservoir and/or pathways of injected carbon dioxide, modelled migration pathways, rock mechanics, temperature, pressure, gravity, density, viscosity; reservoir permeability, reservoir heterogeneities, solubility, fluid chemistry; porosity, fluid saturation, modelled tracer and carbon dioxide injection including tracer and carbon dioxide amounts, volumes and injection rates, injection locations, leakage locations, tracer arrival time, residence time distribution, physical behaviour of CO₂ and/or chemical behaviour of CO₂.

In step 922 a simulation of the CO₂ and tracer injection into the model storage reservoir and simulation data for CO₂ storage, tracer storage, CO₂ leakage and/or tracer leakage may be obtained. The measured tracer data from the samples is compared with the model data shown in step 924. If the model simulation does not match the observed tracer data, the model is tuned or iteratively adjusted at step 926 until the modelled tracer data substantially matches the measured tracer data to within a desired target range. Once the model is calibrated and refined to best match the observed measured data then the amount of tracer and corresponding carbon dioxide stored in the reservoir may be quantified in step 928. Optionally accurate calculation of carbon credit and/or carbon quota offsets may be calculated based on the amount of carbon dioxide stored.

Due to the distribution of the injected tracer and/or carbon dioxide in the reservoir as it migrates in the reservoir, the identification of tracer and/or carbon dioxide at a sampling location does not necessarily mean that all of the injected carbon dioxide is exposed to the leak location. The model may be used to determine what proportion of the injected carbon dioxide is impacted and exposed to a leak location. Factors such as the reservoir geology, reservoir geometry, swept volume and/or residence time distribution of injected carbon dioxide and tracer may affect where in a reservoir the injected carbon dioxide is stored and determine the impact of a leak at specific locations on the storage of the carbon dioxide in the reservoir.

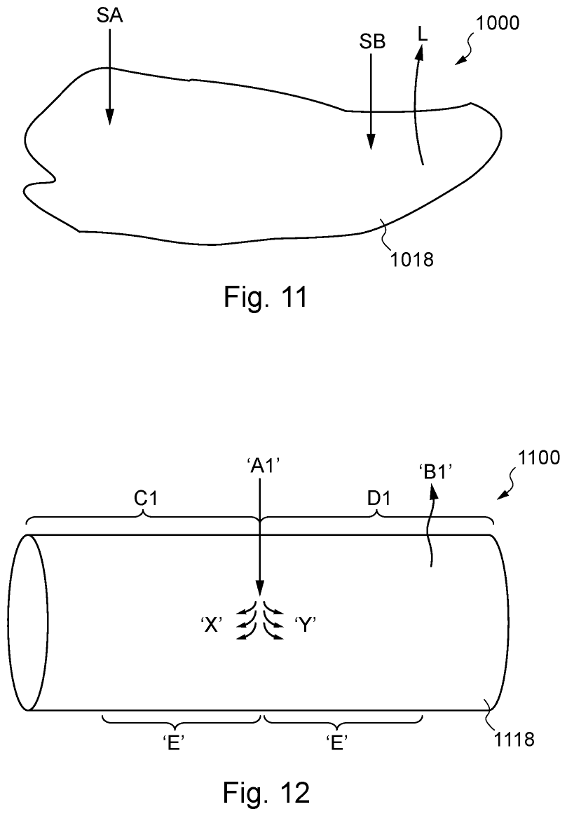

The above example describes modelling of one tracer, one carbon dioxide source, one injection point and one sampling point. It will be appreciated that the model may be adjusted for multiple tracers, multiple carbon dioxide sources, multiple injection points and/or multiple sampling points. FIG. 11 shows a carbon dioxide storage system 1000, in this example the storage reservoir 1018 is configured to store carbon dioxide and associated tracer injected from two different sources “SA” and “SB”. A leak is detected at location “L”. It will be appreciated that the model may be used to determine the amount of carbon dioxide from each source which is stored in the reservoir. The model may be used to determine the exposure of the carbon dioxide from each of the sources to the leak at location “L” and estimate or calculate the amount of carbon dioxide from each source which is stored in the reservoir.

Using the model the distribution of each injected tracer and/or carbon dioxide from each source may be modelled in the reservoir as it migrates in the reservoir. In this example the location of the leak and the geometry of the reservoir affects the injected carbon dioxide from source SA more than source SB. A small percentage (10%) of the injected carbon dioxide from Source SA is exposed to the leak. Tracer from source SA will be initially detected in the samples. However, the majority (90%) of the injected tracer and carbon dioxide from Source SA is not affected by the leak and is stored in the reservoir. In contrast due to the distribution of the injected tracer and/or carbon dioxide from Source SB the location of the leak and the geometry of the reservoir a larger percentage in this example 60% of the injected carbon dioxide from Source SB may be affected by the leak. Only 40% is not affected by the leak and is consider stored long term in the reservoir.

FIG. 12 shows a simple carbon dioxide storage system 1100 in the form of a cylinder to explain the principle of using tracer time arrival to characterise the migration of carbon dioxide and tracer in a storage reservoir. The storage reservoir 1118 is modelled using data selected from the group comprising seismic and geological data, core data, logs, well logs, reservoir and/or pathways of injected carbon dioxide, and modelled migration pathways to determine the volume of reservoir and calculate an expected tracer arrival time at a leak location in the model.

In this example the storage reservoir 1118 is represented by a cylinder of known volume to explain the principle. Carbon dioxide and tracer is injected at midway point A1 and a reservoir leak is located at point B1 of the reservoir. The model would calculate an arrival time of tracer at the point B1 leak location. A model of the reservoir would determine a tracer distribution and migration paths in the reservoir depending on the geology and/or conditions of the storage formation. In this basic example as the injection site is located at a central location and the geology, geometry and conditions of the storage system in reservoir section “C1” and section “D1” are the same, it would be expected that the tracer would distribute substantially equally in sections “C1” and section “D1” as shown by direction arrows “X” and “Y” in FIG. 12. The model expectation is that the tracer would reach a distance “E” from the injection point “A1” after a given time in both directions, where the starting time of the injection is to.

Assuming that leakage at point B1 is instantaneous. If the measured leak detection time (tL) equals the modelled expected time (tE), then the model substantially matches the measured data. If the measured leak detection time (tL) does not equal the expected modelled time (tE), then the carbon dioxide plume and tracer is developing in a different manner than expected by the model and adjustment of the model is required. The model may for example be turned by adjusting the volumes and/or conditions in reservoir section “D1” by a simple linear relationship to the arrival time observed, i.e. 50%*(tE−t0)/tE, and apply this adjustment to reservoir section C1, where no leak is observed and there are no additional data.

In this example modelled expected arrival time of tracer at leak location B1 is 100 days. However, if the measured arrival time at leak location B1 is 50 days, this indicates that the carbon dioxide and tracer plume direction or distribution is not uniform after injection into the reservoir and in this case the plume direction or migration path is uneven with greater migration towards section D1 in direction Y with a faster arrival at the leak location. In this case the model requires adjustment to match the measured data. In contrast, if the measured arrival time at leak location B1 is 200 days, this indicates that the carbon dioxide and tracer plume direction or migration path is uneven with greater migration towards section C1 with a slower arrival at the leak location. By monitoring or tracking the arrival time of a tracer at a leakage location may provide information of carbon dioxide plume development and transport in the reservoir. The time delay between tracer and carbon dioxide injected and arrival at a leakage location may provide information on reservoir conditions, geology, geometry and/or volumes. The measured tracer data may be compared with simulated data to improve the model. The dispersion or distribution of the injected carbon dioxide and tracer in the storage reservoir may be a function of the reservoir geometry. The geometry of the reservoir or a reservoir section may affect the distribution of the carbon dioxide and tracer. As an example if a reservoir section contains cavities, dips or voids they may have an impact on the expected arrival time at a leak location. The geometry of the reservoir or a reservoir section may also impact how much of the injected carbon dioxide and tracer is affected by the leak or exposed to a leak location. Using the above example in FIG. 12, if the reservoir section C1 is higher (closer to surface) than reservoir section D1, the carbon dioxide and tracer in section C1 may be trapped due to the geometry of the reservoir and not exposed to the leak at point B1 in section D1. The model may determine the degree of exposure of injected carbon dioxide and tracer in a reservoir or a section of the reservoir to a leak location. The model may use reservoir geometry, residence time and/or arrival time to determine the degree of exposure of injected carbon dioxide and tracer in a reservoir or a section of the reservoir to a leak location. The model may calculate or estimate an amount of injected carbon dioxide and tracer stored in the reservoir which is not exposed or partially exposed to a leak.

The injection, collection, detection, analysis and/or interpretation of tracer data may each be considered as separate methods from one another and performed at different times or jurisdictions. The detection, analysis and/or interpretation of tracer may be separate methods to injection of tracer and/or the collection of samples. Samples may be analysed and/or interpreted at a time or jurisdiction which is separate and distinct from the location of sampling location and therefore the collection of the samples.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers. Furthermore, relative terms used to indicate directions and locations as they apply to the appended drawings and will not be construed as limiting the invention and features thereof to particular arrangements or orientations.

The invention may provide a system and method of estimating the amount of carbon dioxide stored in a storage formation. The method comprises associating at least one carbon dioxide source with at least one tracer and injecting the carbon dioxide from the at least one carbon dioxide source into the storage formation. The method comprises taking at least one sample from one or more sampling location and measuring the concentration of the tracer in the at least one sample. The method comprises inferring from the presence or absence of the tracer in the sample the amount of injected carbon dioxide remaining in the storage formation.

An embodiment of the invention may facilitate a full account of carbon credits and carbon quota offsetting. The method may facilitate improved understanding, transparency and verification related to an amount of CO₂ permanently stored which gives rise to carbon credits or carbon quota offsets. An embodiment of the invention may facilitate the use of tracer technology, isotope analysis and/or modelling to create a mass balance for CO₂ produced, leaked and injected into an underground reservoir and allocate the various CO₂ inputs and outputs to generate either a carbon credit or a carbon quota account. An embodiment of the invention may facilitate the use of a standardised audit method for carbon credit and quotas, allowing them to be more freely traded across industries and country borders. An embodiment of the invention may mitigate double accounting of CO₂ credits as well as mitigate obstacles to an operator's ability to claim carbon credits or quotas for CO₂ that is not permanently stored. An embodiment of the invention May facilitate determining the distribution of injected carbon dioxide and tracer in a storage reservoir. It may also facilitate determining the proportion of injected carbon dioxide and tracer in a storage reservoir impacted by a leak in the storage reservoir and the proportion of injected carbon dioxide and tracer stored in the storage reservoir. An embodiment of the invention may also facilitate identification of sources or locations of potential seepage of carbon dioxide gas from areas surrounding a carbon dioxide storage project.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A method of estimating an amount of injected carbon dioxide stored in an underground storage formation, the method comprising:
injecting carbon dioxide from at least one carbon dioxide source into the storage formation; wherein the carbon dioxide from each carbon dioxide source is associated with at least one tracer;
collecting samples from one or more sampling locations;
measuring the concentration of the at least one tracer in the samples;
inferring from the presence or absence of the at least one tracer in the samples whether injected carbon dioxide from the at least one carbon dioxide source is leaking from the storage formation; and
estimating the amount of injected carbon dioxide from the at least one carbon dioxide source stored in the underground storage formation.

2. The method according to claim 1 comprising quantifying the amount of injected carbon dioxide remaining in the storage formation based on the measured concentration of the at least one tracer in the collected samples.

3. The method according to claim 1 further comprising analysing the concentration the at least one tracer in the samples as a function of time to estimate the amount of injected carbon dioxide stored in the underground storage formation.

4. The method according to claim 1 further comprising quantifying the amount of carbon dioxide remaining in the storage formation based on the arrival time of the at least one tracer in the collected samples.

5. The method according to claim 1 further comprising quantifying or characterising a carbon dioxide plume or migration path based on the arrival time of the at least one tracer in the collected samples.

6. The method according to claim 1 further comprising calculating a residence time distribution of the at least one tracer in the underground storage formation and/or a swept volume of the at least one tracer in the underground storage formation.

7. The method according to claim 1 further comprising establishing a carbon credit value and/or a carbon quota offset value based on the amount of carbon dioxide remaining in the storage formation.

8. The method according to claim 1 wherein the at least one tracer is selected from the group comprising chemical, fluorescent, phosphorescent, DNA, isotope signature and/or radioactive tracer materials.

9. The method according to claim 1 further comprising detecting and/or quantifying an isotope signature of carbon dioxide in the collected samples.

10. The method according to claim 9 further comprising quantifying the amount of carbon dioxide remaining in the storage formation based on measuring the amount of at least one tracer and an isotope signature of carbon dioxide in the collected samples.

11. The method according to claim 1 wherein a rate of injection is measured volumetrically and/or by mass flow rate.

12. The method according to claim 1 wherein the one or more sampling locations surrounds, partially surrounds, is in proximity and/or is connected to the storage formation.

13. The method according to claim 1 wherein the one or more sampling locations is a well, production well, section of seabed, section of land surface and/or observation well.

14. The method according to claim 1 further comprising creating a model of the storage formation.

15. The method according to claim 14 wherein the model comprises parameters selected from the group consisting of: seismic data, geological data, reservoir geometry, core data, log data, reservoir and/or pathways of injected carbon dioxide, modelled migration pathways, rock mechanics, temperature, pressure, gravity, density, viscosity; reservoir permeability, reservoir heterogeneities, solubility, fluid chemistry; porosity, fluid saturation, modelled tracer and carbon dioxide injection including tracer and carbon dioxide amounts, volumes and injection rates, injection locations, leakage locations, arrival time, residence time distribution, physical behaviour of CO₂ and/or chemical behaviour of CO.

16. The method according to claim 14 further comprising simulating characteristics of the reservoir and/or pathways of injected carbon dioxide and at least one tracer, and comparing modelled tracer sample data to measured tracer sample data.

17. The method according to claim 16 comprising adjusting one or more parameters of the model to calibrate the modelled tracer sample data to the measured tracer sample data.

18. The method according to claim 1 wherein the storage formation is a reservoir, a subsurface reservoir, an oil and/or gas reservoir, a saline formation, an abandoned coal seam, an organic-rich shale and/or a basalt formation.

19. The method according to claim 1 further comprising characterising and/or identifying the source of a leak of carbon dioxide stored in a storage formation based on the characteristics of the at least one tracer and/or an isotope signature of carbon dioxide in the collected samples.

20. A method for estimating an amount of injected carbon dioxide stored in a storage formation wherein the storage formation comprises carbon dioxide injected from at least one carbon dioxide injection source; wherein injected carbon dioxide from each carbon dioxide source is associated with at least one tracer, the method comprising:
collecting samples from one or more sampling locations;
measuring the concentration of the at least one tracer in the collected samples;
inferring from the presence or absence of the at least one tracer in the samples whether injected carbon dioxide from the at least one carbon dioxide source is leaking from the storage formation; and
estimating the amount of injected carbon dioxide from the at least one carbon dioxide source stored in the underground storage formation.

21. The method according to claim 20 wherein the storage formation comprises carbon dioxide originating from two or more carbon dioxide injection sources and the method comprises inferring from the presence of the at least one tracer in the samples which carbon dioxide injection source is leaking from the carbon dioxide storage formation.

22. The method according to claim 20 further comprising quantifying the amount of carbon dioxide from each carbon dioxide injection sources is stored in the carbon dioxide storage formation.

23. A method for determining a carbon credit value and/or carbon quota offset value for carbon dioxide stored in a carbon dioxide underground storage formation, the method comprising:
providing at least one carbon dioxide source;
associating at least one carbon dioxide source with at least distinctive tracer specific for the carbon dioxide source;
injecting a known amount of carbon dioxide from the at least one of the carbon dioxide source into the carbon dioxide storage formation;
collecting samples from one or more sampling locations;
measuring the concentration of the at least one tracer in the samples;
inferring from the presence or absence of the tracer in the at least one sample a leak from the carbon dioxide storage formation;
estimating the amount of injected carbon dioxide from the at least one carbon dioxide source stored in the underground storage formation; and
estimating or calculating a carbon credit value and/or carbon quota offset value depending on the amount of injected carbon dioxide remaining in the storage formation.

24. A system for estimating an amount of carbon dioxide stored in an underground storage formation, comprising:
at least one source of carbon dioxide with at least one tracer;
at least one injection device configured to inject carbon dioxide from the at least one source of carbon dioxide and the at least one tracer into the storage formation;
a sampling device for collecting samples;
analysing equipment configured to detect the type of tracer and/or concentration of tracer in the samples; and
at least one processor configured to estimate the amount of injected carbon dioxide from the at least one carbon dioxide source stored in the underground storage formation.

25. The system according to claim 24 wherein the at least one processor is configured to perform at least one tracer flow simulation to generate a model tracer data set and compare the model tracer data set with a measurement data set to estimate an amount of carbon dioxide stored in an underground storage formation.
